(19) United States
(12) Patent Application Publication
(10) Pub. No.: US 2003/0064649 A1
(43) Pub. Date: Apr. 3, 2003

(54) Sound absorbing material and interior material using the same

(76) Inventors: Hiroaki Miura, Kanagawa (JP); Katsumi Morohoshi, Kanagawa (JP); Masashi Ito, Kanagawa (JP)

Correspondence Address: FOLEY AND LARDNER, SUITE 500, 3000 K STREET NW, WASHINGTON, DC, 20007, US

(21) Appl. No.: 09/506,489

(22) Filed: Feb. 18, 2000

(30) Foreign Application Priority Data
Feb. 18, 1999 (JP) 11-39553

(51) Int. Cl. D04H 1/00; D04H 3/00; D04H 5/00; D04H 13/00; B32B 5/26; B32B 27/02

(52) U.S. Cl. 442/340; 442/351; 442/381; 442/392

(57) ABSTRACT

A dash insulator for an automotive vehicle is formed of an interior material which includes a sound absorbing material layer, and a moldable layer. The sound absorbing material layer includes first and second polyester fibers (A), (C). The first polyester fiber (A) is in an amount ranging from 20 to 95 parts by weight. The first polyester fiber has a size smaller than 1 denier. The second polyester fiber (C) is in an amount ranging from 5 to 50 parts by weight. The second polyester fiber includes a component having a softening point lower than that of the first polyester fiber by at least a temperature of 20° C. The second polyester fiber has a size ranging from 1 to 100 denier. The moldable layer is laminated to the sound absorbing material layer and includes fourth polyester fiber (E) in an amount ranging from 5 to 100 parts by weight. The fourth polyester fiber has a size ranging from 1 to 100 denier.

### BACKGROUND OF THE INVENTION

This invention relates to improvements in a sound absorbing material and an interior material using the sound absorbing material, and more particularly to the interior material high in sound insulating performance and moldability and to a method for producing the interior material, the interior material being suitable for an automotive sound-insulating material such as a dash insulator.

In recent years, requirement of quietness for automotive vehicles have been increasing, so that materials for effectively reducing noise transmission to a passenger compartment are eagerly required. Particularly interior materials for contributing to quietness of the passenger compartment are strongly required. In this connection, interior trim materials for a door, a head lining, a floor carpet, a dash insulator and the like are being required to exhibit high sound insulating performance and humidity absorbing performance.

In an automotive vehicle, a dash insulator is, in general, located at the passenger compartment-side of a dash panel which separates a passenger compartment from an engine compartment so as to serve to prevent noise from being transmitted from the engine compartment to the passenger compartment. Such a dash insulator is usually formed of a laminated structure which includes an air impermeable plastic or polymer layer such as a vinyl chloride layer filled with fillers, or a rubber sheet, and a fiber bulk material layer formed of a porous material such as polyurethane foam or a nonwoven fabric. With such a dash insulator, the fiber bulk material layer absorbs noise from the engine compartment and exhibits a good sound transmission-preventing effect under the action of a two-layer structure of the dash panel and the plastic layer, thereby accomplishing a good sound insulating performance.

However, difficulties have been encountered in the above conventional dash insulator. That is, the dash insulator is lowered in moldability in case that size of fibers constituting the above-mentioned fiber bulk material layer is reduced for the purpose of improving the sound insulating performance. For example, in a conventional technique disclosed in Japanese Patent Provisional Publication No. 9-48042, fibers having sizes smaller than 10 μm or about 1 denier are not used for constituting a fiber bulk material layer in order to prevent the moldability from lowering.

### SUMMARY OF THE INVENTION

It is an object of the present invention to provide improved sound absorbing material and interior material using the sound absorbing material, which can overcome drawbacks encountered in conventional sound absorbing materials and interior materials.

Another object of the present invention is to provide improved sound absorbing material and interior material using the sound absorbing material, which are largely improved in sound insulating performance while maintaining a high moldability.

A further object of the present invention is to provide an improved dash insulator for an automotive vehicle, which is largely improved in sound insulating performance while maintaining a high moldability.

A first aspect of the present invention resides in a sound absorbing material comprising first and second polyester fibers (A), (B). The first polyester fiber (A) is in an amount ranging from 20 to 95 parts by weight. The first polyester fiber has a size smaller than 1 denier. The second polyester fiber (C) is in an amount ranging from 5 to 50 parts by weight. The second polyester fiber includes a component having a softening point lower than that of the first polyester fiber by at least a temperature of 20° C. The second polyester fiber has a size ranging from 1 to 100 denier.

A second aspect of the present invention resides in an interior material comprising a sound absorbing material layer, and a moldable layer. The sound absorbing material layer includes first and second polyester fibers (A), (C). The first polyester fiber (A) is in an amount ranging from 20 to 95 parts by weight. The first polyester fiber has a size smaller than 1 denier. The second polyester fiber (C) is in an amount ranging from 5 to 50 parts by weight. The second polyester fiber includes a component having a softening point lower than that of the first polyester fiber by at least a temperature of 20° C. The second polyester fiber has a size ranging from 1 to 100 denier. The moldable layer is laminated to the sound absorbing material layer and includes fourth polyester fiber (E) in an amount ranging from 5 to 100 parts by weight. The fourth polyester fiber has a size ranging from 1 to 100 denier.

A third aspect of the present invention resides in a method of producing an interior material, comprising: (a) preparing a sound absorbing material layer including first polyester fiber (A) in an amount ranging from 20 to 95 parts by weight, the first polyester fiber having a size smaller than 1 denier, and second polyester fiber (C) in an amount ranging from 5 to 50 parts by weight, the second polyester fiber including a component having a softening point lower than that of the first polyester fiber by at least a temperature of 20° C., the second polyester fiber having a size ranging from 1 to 100 denier; (b) preparing a moldable layer including fourth polyester fiber (E) in an amount ranging from 5 to 100 parts by weight, the fourth polyester fiber having a size ranging from 1 to 100 denier; and (c) heat-treating the sound absorbing material and moldable layers at a temperature which is not lower than the highest one of the softening points of the second polyester fiber (C) and the fourth polyester fiber (E) and lower than the softening point of the first polyester fiber (A) by at least a temperature of 20° C., so that the sound absorbing material and moldable layers are bonded to each other.

A fourth aspect of the present invention resides in a method of producing an interior material, comprising: (a) preparing a sound absorbing material layer including first polyester fiber (A) in an amount ranging from 20 to 95 parts by weight, the first polyester fiber having a size smaller than 1 denier, second polyester fiber (C) in an amount ranging from 5 to 50 parts by weight, the second polyester fiber including a component having a softening point lower than that of the first polyester fiber by at least a temperature of 20° C., the second polyester fiber having a size ranging from 1 to 100 denier, and third polyester fiber (B) in an amount ranging from 1 to 5 parts by weight, the third polyester fiber having a size ranging from 1 to 100 denier; (b) preparing a moldable layer including fourth polyester fiber (E) in an amount ranging from 5 to 100 parts by weight, the fourth polyester fiber having a size ranging from 1 to 100 denier, and fifth polyester fiber (D) in an amount ranging from 1 to 95 parts by weight, the fifth polyester fiber including a component having a softening point higher than that of the fourth polyester fiber by at least a temperature of 20° C., the fifth polyester fiber having a size ranging from 1 to 100 denier; and (c) heat-treating the superposed sound absorbing material and moldable layers at a temperature which is not lower than the highest one of the softening points of the second polyester fiber (C) and the fourth polyester fiber (E) and lower by at least a temperature of 20° C. than the lowest one of the softening points of the first polyester fiber (A), the third polyester fiber (B) and the fifth polyester fiber (D), so that the sound absorbing material and moldable layers are bonded to each other.

A fifth aspect of the present invention resides in a dash insulator for an automotive vehicle, comprising an interior material which includes a sound absorbing material layer, and a moldable layer. The sound absorbing material layer includes first and second polyester fibers (A), (C). The first polyester fiber (A) is in an amount ranging from 20 to 95 parts by weight. The first polyester fiber has a size smaller than 1 denier. The second polyester fiber (C) is in an amount ranging from 5 to 50 parts by weight. The second polyester fiber includes a component having a softening point lower than that of the first polyester fiber by at least a temperature of 20° C. The second polyester fiber has a size ranging from 1 to 100 denier. The moldable layer is laminated to the sound absorbing material layer and includes fourth polyester fiber (E) in an amount ranging from 5 to 100 parts by weight. The fourth polyester fiber has a size ranging from 1 to 100 denier.

### BRIEF DESCRIPTION OF THE DRAWINGS

In the drawings, like reference numerals designate like parts and elements throughout all figures, in which:

FIG. 1 is a schematic sectional view of an automotive vehicle provided with a dash insulator including an interior material according to the present invention;

FIG. 2 is an enlarged schematic sectional view of the interior material of FIG. 1;

FIG. 3 is a fragmentary schematic sectional view of an example of the interior material according to the present invention;

FIG. 4 is a fragmentary schematic sectional view of another example of the interior material according to the present invention;

FIG. 5 is a fragmentary schematic sectional view of an example of a dash insulator for an automotive vehicle, constituted of the interior material according to the present invention;

FIG. 6 is a schematic illustration showing operation of a pressing machine used for evaluation of moldability for the interior material according to the present invention; and

FIG. 7 is a graph showing comparison data for evaluation of moldability of a variety of samples including the interior materials according to the present invention.

### DETAILED DESCRIPTION OF THE INVENTION

A sound absorbing material according to the present invention comprises two polyester fibers (A), (C). The polyester fiber (A) is in an amount ranging from 20 to 95 parts by weight. The polyester fiber (A) has a size smaller than 1 denier. The polyester fiber (C) is in an amount ranging from 5 to 50 parts by weight. The polyester fiber (C) includes a component having a softening point lower than that of the polyester fiber (A) by at least a temperature of 20° C. The polyester fiber (C) has a size ranging from 1 to 100 denier. Additionally, the sound absorbing material may comprise polyester fiber (B) having a size ranging from 1 to 100 denier, in an amount ranging from 1 to 50 parts by weight, as occasion demands.

Thus, the sound absorbing material is required to be mainly or only constituted of fibers formed of polyester for the reasons set forth below.

The sound absorbing material is required to be mainly or only constituted of thermoplastic synthetic fiber because molding of the sound absorbing material is accomplished under heating. Examples of such thermoplastic synthetic fiber are aliphatic polyamide fiber such as nylon 66 fiber, polyester fiber such as polyethylene terephthalate fiber, polyphenylene sulfide (PPS) fiber and polyether ether ketone fiber, and a mixture fiber in which the above-listed fibers are suitably mixed. It is to be noted that the polyester fiber of the above-listed fibers is appropriate for the sound absorbing material because of being high in air-permeability and mechanical strength and high in cost performance.

Examples of polyester suitably used for the above-mentioned polyester fiber are polyethylene terephthalate (PET), polybutylene terephthalate (PBT), polyethylene naphthalate (PET), polyethylene isophthalate (PEI), polybutylene isophthalate (PBI), ploy-ε-caprolactone (PCL), a polymer prepared by substituting ethylene glycol component of polyethylene terephthalate with other different glycol component (for example, polyhexamethylene terephthalate (PHT)), and a polymer prepared by substituting terephthalic acid component with other different dibasic acid component, the polymer being, for example, polyhexamethylene isophthalate (PHI), polyhexamethylene naphthalate (PHN)), and the like. The polyester for the above-mentioned polyester fiber may be a mixture polymer which is prepared by mixing two or more of the above-listed polyesters. Additionally, the polyester for the above-mentioned polyester fiber may be polyester copolymer including at least one of the above-listed polyester as a structural unit. Examples of such polyester copolymer are a block copolymer of polybutylene terephthalate (PBT) and polytetramethylene glycol (PTMG), a copolymer of polyethylene terephthalate (PET) and polyethylene isophthalate (PEI), a copolymer of polybutylene terephthalate (PBT) and polybutylene isophthalate (PBI), a copolymer of polybuthylene terephthalate (PBT) and poly-e-caprolactone (PCL), and the like. Further, the polyester for the above-mentioned polyester may be a copolymer including polyester as main repeated structural unit.

The polyester fiber (A) has the size smaller than 1 denier because of improving a sound insulating performance of a sound absorbing material (layer) and of an interior material including the sound absorbing material. More specifically, in general, a fiber spring constant of a fiber structural material becomes lower as stiffness and size of each fiber lower, improving a sound insulating performance of the fiber structural material. The polyester fiber (A) occupies the largest part of the polyester fibers constituting the sound absorbing material (layer) and serves as the main fiber which largely contributes to the sound insulating performance. Accordingly, the polyester fiber having the size smaller than 1 denier is used as the polyester fiber (A), in which the polyester fiber (A) has a lower fiber spring constant thereby realizing the sound absorbing material layer having a high sound absorbability.

The polyester fiber (A) is blended in an amount (blended amount) ranging from 20 to 95 parts by weight to form the sound absorbing material. The sound absorbing performance of the sound absorbing material is improved as finer fiber is blended. However, if the blended amount of the polyester fiber (A) exceeds 95 parts by weight, air flow resistance of the sound absorbing material increases to an impermissible level so as to degrade the spring constant. If the blended amount is less than 20 parts by weight, no effect of blending the polyester fiber (A) can be obtained.

The polyester fiber (C) is required to mold the sound absorbing material to form the sound absorbing material layer, in which the polyester fiber (C) functions to bond polyester fibers each other, forming joint points (or portions) for the polyester fibers. The polyester fiber (C) is blended in the amount (blended amount) ranging from 5 to 50 parts by weight. If the blended amount is less than 5 parts by weight, the joint points among the polyester fibers become less thereby making it impossible to maintain a bulky structure of the sound absorbing material (layer). If the blended amount exceeds 50 parts by weight, the sound absorbing material (layer) is unavoidably hardened after being subjected to a heat treatment, so as to be degraded in sound insulating performance.

The polyester fiber (C) includes the component which has a softening point lower than that of the polyester fiber (A) by at least 20° C. The polyester fiber (C) may be formed of only the component having such a softening point. The reason why the softening point difference of the polyester fiber (C) from the polyester fiber (A) is at least 20° C. is as follows: If the softening point difference is smaller than 20° C., the whole fiber bulk material of the sound absorbing material (layer) is unavoidably softened and therefore will become plate-shaped when pressed upon heating. The fiber bulk material is required to be heated and pressed to obtain the sound absorbing material (layer) which maintains its bulky structure thereof.

It is preferable that the sound absorbing material further comprises polyester fiber (B) having the size ranging from 1 to 100 denier, in an amount (blended amount) ranging from 1 to 50 parts by weight. This suppresses lowering in sound insulating performance, due to the fact that the total spring constant of the sound absorbing material (layer) becomes too high. In this regard, the sound absorbing ability of the sound absorbing material (layer) is improved by blending the fine polyester fiber (A); however, the total spring characteristics of the fiber bulk material or sound absorbing material (layer) can be determined only in accordance with the spring characteristics of the fibers and therefore is affected by the spring characteristics due to air. The spring characteristics due to air tends to degrade as the size of fibers becomes smaller, because the air flow resistance in the sound absorbing material (layer) increases to make difficult movement of air through spaces among fibers as the size of the fibers becomes smaller. In view of this, it is preferable to blend the polyester fiber (B) in order to allow the sound absorbing material (layer) to ensure a certain amount of air flow therein. However, if the blended amount of the polyester (B) is too large, the total fiber spring constant of the sound absorbing material (layer) becomes high thereby to degrade the sound insulating performance. Consequently, it is preferable that the blended amount of the polyester (B) is not larger than 50 parts by weight in order to maintain the sound insulating performance at a suitable level.

Next, interior materials 4 using the above sound absorbing material will be discussed with reference to drawings.

As shown in FIG. 3, an example 4A of an interior material 4 includes the sound absorbing material layer 5 to which a moldable layer 6 is laminated. The sound absorbing material layer 5 is formed of the above-discussed sound absorbing material. The moldable layer 6 includes polyester fiber (E) having a size ranging from 1 to 100 denier. The moldable layer 6 may further include polyester fiber (D) which has a size ranging from 1 to 100 denier and includes a component having a softening point higher by at least 20° C. than that of the polyester fiber (E).

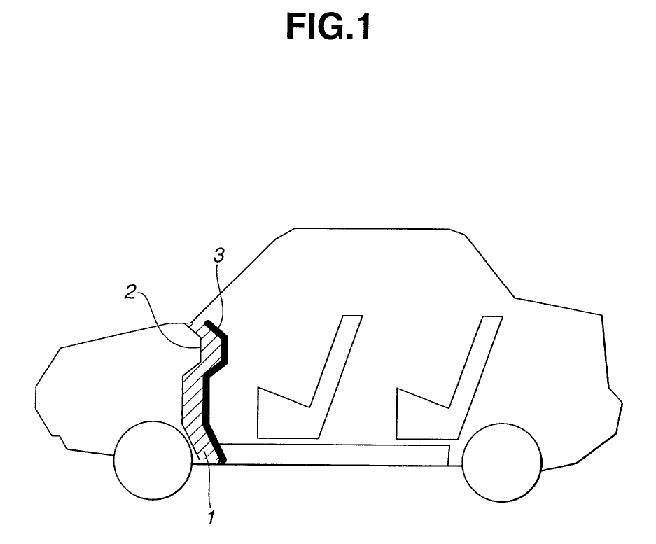

The reason why the size of the polyester fiber (E) is within the range of from 1 to 100 denier is as follows: The interior material 4A requires a good moldability which mainly depends on the moldability of the moldable layer 6. For example, the interior material 4A is used as a fiber bulk material layer or interior material 4 serving as a dash insulator 1 as shown in FIG. 1. The fiber bulk material layer 4 is disposed between a dash panel 2 and a polymer or plastic layer 3. The fiber bulk material layer 4 is required to be molded to have a complicated shape corresponding to that of the dash panel 2, so as to require a good moldability.

The polyester fiber (E) is blended in an amount (blended amount) ranging from 5 to 100 parts by weight in the moldable layer 6. If the blended amount is less than 5 parts by weight, a sufficient moldability for the interior material 4A cannot be obtained.

It is preferable that the polyester fiber (D) is further blended in the moldable layer 6. The polyester fiber (D) has a size ranging from 1 to 100 denier and a softening point higher by at least 20° C. than that of the polyester fiber (E). The reason why blending the polyester fiber (D) is preferable is as follows: The moldable layer 6 constituted of the polyester fiber having a larger size is laminated to the sound absorbing material layer 5 whose main part is occupied with the polyester fiber having a smaller size, so that air in the sound absorbing material layer 5 can be readily moved into the moldable layer 6. Specifically, air is difficult to move in the sound absorbing material layer which is high in air flow resistance, so that air moves into the moldable layer low in air flow resistance because of the larger fiber size. Accordingly, in the whole interior material 4A constituted of the sound absorbing and moldable layers 5, 6 which are laminated to each other, the spring characteristics of the interior material 4A due to air can be effectively lowered, thereby further lowering the total spring constant of the interior material 4A. Thus, the interior material 4A can be improved in sound insulating performance as compared with an interior material which is constituted of only the sound absorbing material layer (5). The polyester fiber (D) is preferably blended in order to effectively exhibit a lowering effect for the spring characteristics due to air.

In this regard, the size of the polyester fiber (D) is within the range of from 1 to 100 denier. If the size is smaller than 1 denier, the polyester fiber of the moldable layer 6 becomes the generally same in size as that of the sound absorbing material layer 5, and therefore the moldability of the interior material 4A cannot be improved. Thus, the moldable layer 6 uses the larger size fiber than the sound absorbing material layer 5, thereby achieving both an improvement in moldability and a lowering in the air spring effect and the total spring constant of the interior material 4A. In view of this, it is more preferable that the polyester fiber (D) has the size ranging from 5 to 100 denier in order to improve the lowering effect for the total spring characteristics of the interior material 4A. If the size of the polyester fiber (D) exceeds 100 denier, the number of fibers is reduced, and therefore not only the sound absorbing ability is lowered but also the stiffness of fiber itself is increased to raise the spring constant thus to degrade the sound insulating performance.

It is preferable that the polyester fiber (D) is blended in an amount (blended amount) ranging from 1 to 95 parts by weight in the moldable layer 6. If the blended amount exceeds 95 parts by weight, not only maintaining the shape of the moldable layer 6 itself is difficult but also the moldability of the interior material 4A having a multi-layer structure is degraded.

The moldable layer 6 may be constituted of only the polyester fiber (E) without blending the polyester fiber (D). Even with this moldable layer, the moldability and sound insulating performance of the interior material 4A can be improved; however, it will be understood that blending the polyester fiber (D) may further lower the total spring constant of the interior material 4A and therefore may further improve the sound insulating performance of the interior material 4A.

Although the polyester fiber (D) has been described as including the component having the softening point higher at least 20° C. than that of the polyester fiber (E), it will be understood that the polyester fiber (D) may be formed of only the component having such a softening point. Such a difference in softening point from the polyester fiber (E) is preferable from the viewpoints of obtaining the interior material or product 4 by pressing the fiber bulk material upon heating while maintaining the shape of the moldable layer. If the softening point difference is lower than 20° C., there is the possibility of the whole fiber bulk material being softened.

FIG. 4 illustrates another example 4B of the interior material 4 which is denoted by the reference numeral 4B, similar to the example of FIG. 3. In this example, the sound absorbing material layer 5 is put between the moldable layers 6, 6 in such a manner that the moldable layers 6, 6 are laminated respectively at the opposite surfaces of the sound absorbing material layer 5, thereby forming a three-layer structure.

With this example, the moldability of the interior material 4B is further improved. Assuming that the sound absorbing material layers 5, 5 are laminated respectively at the opposite surfaces of the single moldable layer, there is the possibility of the moldability of the interior material 4B being degraded because of using the low-moldability sound absorbing material layers as surface layers. In this example, it is preferable that the sound absorbing material layer has a thickness ranging from 40 to 95% of the total thickness of the interior material 4B, whereas the moldable layer 6 has a thickness ranging from 5 to 60% of the total thickness of the interior material 4B.

The sound absorbing material layer 5 is mainly intended to improve the sound insulating performance of the interior material 4B, and therefore it is preferable to increase the thickness of the sound absorbing material layer 5 as large as possible. If the thickness is less than 40% of the total thickness of the interior material 4B, there is the possibility of the sound insulating performance being largely degraded. More preferably, the thickness of the moldable layer 6 is within a range of from 70 to 95% of the total thickness of the interior material 4B. The moldable layer 6 is mainly intended to provide the moldability to the interior material 4B. In this regard, if the thickness of the moldable layer 6 is less than 5% of the total thickness of the interior material 4B, a good moldability of the interior material 4B cannot be maintained. If the thickness exceeds 60%, there is the possibility of the sound insulating performance of the interior material 4B being largely degraded.

While the interior materials of the two-layer structure and the three-layer structure have been shown in FIGS. 3 and 4, it will be understood that the interior material may take other structures, for example, a multiple-layer structure such as a four or more-layer structure, in which it is sufficient that the interior material 4 includes at least one sound absorbing material layer 5 and at least one moldable layer 6. Additionally, the order of laminating the sound absorbing material layer and the moldable layer is not limited to ones of the examples shown in FIGS. 3 and 4, in which the order may be “the moldable layer—the moldable layer—the sound absorbing material layer—. . . ” or “the moldable layer—the sound absorbing material layer—the sound absorbing material layer—. . . ”. In such a multiple-layer structure, it is sufficient that the above-discussed thickness rates (%) of the sound absorbing material layer and the moldable layer are met with the total thickness of the sound absorbing material layers and the total thickness of the moldable layers.

Next, a method of producing the interior material 4 will be discussed.

In this instance, the interior material is formed by laminating the sound absorbing material layer 5 and the moldable layer 6. The sound absorbing material layer 5 is formed of the sound absorbing material including 20 to 95 parts by weight of the polyester fiber (A), 1 to 50 parts by weight of the polyester fiber (B) and 5 to 50 parts by weight of the polyester fiber (C). The moldable layer 6 includes 5 to 100 parts by weight of the polyester fiber (E) and 1 to 95 parts by weight of the polyester fiber (D).

In the production method of the above-mentioned interior material 4, the sound absorbing material layer 5 and the moldable layer 6 are heat-treated at a temperature which is higher than the highest one of the softening points of the polyester fibers (C) and (E) and which is lower by at least 20° C. than the lower value of the softening points of the polyester fibers (A), (B) and (D), so that the sound absorbing and moldable layers 5, 6 are bonded to each other. According to this production method, the sound absorbing and moldable layers 5, 6 can be simultaneously molded by making the heat treatment under the above condition in which a heating control is suitably accomplished taking account of difference among softening points of the constituent polyester fibers. It is preferable that the polyester fibers (C) and (E) have the same softening temperature; however, no limitation is made for such an arrangement. Additionally, it is preferable that the polyester fibers (A), (B) and (C) have respectively the softening points which are higher by at least 20° C. than the respective softening points of the polyester fibers (C) and (E); however, no limitation is made for such an arrangement.

It will be understood that the sound absorbing and moldable layers 5, 6 are bonded to each other by using a needle punch method or an adhesive. Additionally, in case that it is difficult to bond the sound absorbing and moldable layers 5, 6 under the heat treatment, the sound absorbing material layer 5 and the moldable layer 6 may be heat-treated separately, and then bonded to each other by using the needle punch method or the adhesive.

Preferably, the interior material 4 of the present invention is produced as follows: The sound absorbing material layer 5 is formed by mixing the polyester fibers (A), (B) and (C) to be formed into laminated webs by using a web production device such as a card layer or an air layer. The moldable layer 6 is formed by mixing the polyester fibers (D) and (E) to be formed into laminated webs by using the web production device. Each laminated webs of the sound absorbing material layer 5 and the moldable layer 6 are heat-treated at 165° C. for 10 minutes and then subjected to pressing under heating at 60° C. Thereafter, the laminated webs of the sound absorbing material layer 5 and the laminated webs of the moldable layer 6 are laminated and heated at 165° for 10 minutes, thus obtaining the interior material 4.

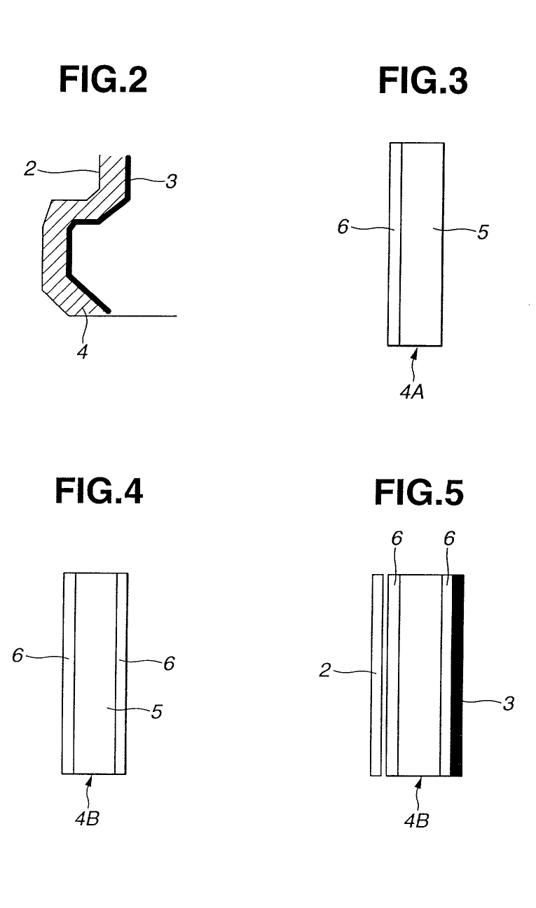

Subsequently, a dash insulator 1 for an automotive vehicle, according to the present invention will be discussed. The interior material 4 discussed above forms part or whole of the dash insulator. The interior material 4 can be not only improved in sound insulating performance under the effect of the excellent characteristics thereof, but also lightened in weight as compared with the conventional interior materials since it is formed of the fiber bulk material. Additionally, the interior material 4 is high in moldability and therefore can be readily realized to form the dash insulator 1 of the complicated shape as shown in FIGS. 1 and 2. Furthermore, since the interior material 4 is formed only or mainly of the polyester fibers, the interior material 4 is readily reusable upon recovery, which can meet recent requirements for recovery and ecology.

An example of the dash insulator 1 is shown in FIG. 5. The dash insulator includes the sound absorbing material layer 5 which is put between the moldable layers 6, 6 in such a manner that the moldable layers 6, 6 are laminated respectively at the opposite surfaces of the sound absorbing material layer 5. In other words, the moldable layers 6, 6 are located respectively at the side of the dash panel 2 (or the side of the engine compartment) and at the side of the plastic layer 3 (or the side of the passenger compartment). In this dash insulator, the moldable layers 6 are laminated on the opposite surfaces of the sound absorbing material layer 5, and therefore is high in sound insulating performance and good in moldability. It will be understood that a sufficient performance may be obtained by laminating the moldable layer 6 at either one side of the dash panel 2 and the plastic layer 3.

### EXAMPLES

The present invention will be more readily understood with reference to the following Examples in comparison with Earlier Technology and Comparative Examples; however, these Examples are intended to illustrate the invention and are not to be construed to limit the scope of the invention.

### Example 1

A sound absorbing material layer was prepared to include 65% by weigh of a polyester fiber (A) having a size of 0.5 denier, 15% by weight of a polyester fiber (B) having a size of 6 denier, and 20% by weight of a polyester fiber (C) having a size of 2 denier, to have a thickness of 90% of the total thickness of a fiber bulk material (or an interior material) and to have a density of 900 g/m². A moldable layer was prepared to include 80% by weight of a polyester fiber (D) having a size of 13 denier and 20% by weight of a polyester fiber (E) having a size of 4 denier, to have a thickness of 10% of the total thickness of the fiber bulk material and to have a density of 100 g/m². The sound absorbing material layer and the moldable layer were put one upon another to form the fiber bulk material. The fiber bulk material was heated at 165° C. for 10 minutes and then pressed at 60° C. for 1 minute, thereby obtaining the two-layer structure interior material having a thickness of 10 mm and a surface density of 1000 g/m². The details of the thus obtained interior material were shown in Table 1.

### Example 2

An interior material of this example was obtained by carrying out a production process similar to that in Example 1 with the exception that the sound absorbing material layer had a thickness of 70% of the total thickness of the fiber bulk material and a density of 700 g/m², and that the moldable layer had a thickness of 30% of the total thickness of the fiber bulk material and a density of 300 g/m².

### Example 3

An interior material (having the three-layer structure) of this example was obtained by carrying out a production process similar to that in Example 1 with the exception that the sound absorbing material layer had a thickness of 80% of the total thickness of the fiber bulk material and a density of 800 g/m², and that each of two moldable layers had a thickness of 10% of the total thickness of the fiber bulk material.

### Example 4

An interior material of this example was obtained by carrying out a production process similar to that in Example 3 with the exception that the sound absorbing material layer had a thickness of 70% of the total thickness of the fiber bulk material and a density of 700 g/m², and that each of two moldable layers had a thickness of 15% of the total thickness of the fiber bulk material.

### Example 5

An interior material of this example was obtained by carrying out a production process similar to that in Example 1 with the exception that the sound absorbing material layer included 80% by weight of the polyester fiber (A) and did no include the polyester fiber (B).

### Example 6

An interior material of this example was obtained by carrying out a production process similar to that in Example 5 with the exception that the sound absorbing material layer included 95% by weight of the polyester fiber (A) and 5% by weight of the polyester fiber (C).

### Example 7

An interior material of this example was obtained by carrying out a production process similar to that in Example 5 with the exception that the sound absorbing material layer included 50% by weight of the polyester fiber (A) and 50% by weight of the polyester fiber (C).

### Example 8

An interior material of this example was obtained by carrying out a production process similar to that in Example 1 with the exception that the moldable layer included 95% by weight of the polyester fiber (D) and 5% by weight of the polyester fiber (E).

### Example 9

An interior material of this example was obtained by carrying out a production process similar to that in Example 1 with the exception that the moldable layer included 50% by weight of the polyester fiber (D) having a size of 6 denier, and 50% by weight of the polyester fiber (E).

### Example 10

An interior material of this example was obtained by carrying out a production process similar to that in Example 1 with the exception that the moldable layer did not include the polyester fiber (D), and included 100% by weight of the polyester fiber (E) having a size of 15 denier.

### Example 11

An interior material of this example was obtained by carrying out a production process similar to that in Example 1 with the exception that the polyester fiber (D) in the moldable layer had a size of 100 denier.

### Example 12

An interior material of this example was obtained by carrying out a production process similar to that in Example 1 with the exception that the polyester fiber (E) in the moldable layer had a size of 100 denier.

### Example 13

An interior material of this example was obtained by carrying out a production process similar to that in Example 1 with the exception that the polyester fiber (D) in the moldable layer had a size of 2 denier.

### Example 14

An interior material of this example was obtained by carrying out a production process similar to that in Example 1 with the exception that the polyester fiber (E) in the moldable layer had a size of 2 denier.

### Earlier Technology 1

An interior material of this technology was obtained by carrying out a production process similar to that in Example 1 with the following exception: The sound absorbing material layer was prepared to include 60% by weight of the polyester fiber (A) having a size of 2 denier, 20% by weight of the polyester fiber (B) having a size of 6 denier, and 20% by weight of the polyester fiber (C) having a size of 2 denier, to have a thickness of 95% of the total thickness of the fiber bulk material (or the interior material) and to have a density of 950 g/m²; and the moldable layer was prepared to include 95% by weight of the polyester fiber (D) having a size of2 denier and 5% by weight of the polyester fiber (B) having a size of 2 denier, to have a thickness of 5% of the total thickness of the fiber bulk material and to have a density of 50 g/m².

### Earlier Technology 2

An interior material (having the three-layer structure) of this technology was obtained by carrying out a production process similar to that in Earlier Technology 1 with the exception that the sound absorbing material layer had a thickness of 88% of the total thickness of the fiber bulk material and a density of 880 g/m², and that each of two moldable layers had a thickness of 6% of the total thickness of the fiber bulk material and a density of 60 g/m².

### Comparative Example 1

An interior material of this comparative example was obtained by carrying out a production process similar to that in Example 1 with the exception that the sound absorbing material layer had a thickness of 100% of the total thickness of the fiber bulk material so that the interior material was of the single-layer structure.

### Comparative Example 2

An interior material of this comparative example was obtained by carrying out a production process similar to that in Example 1 with the exception that the moldable layer included 95% by weight of the polyester fiber (D) and 5% by weight of the polyester (E).

### Comparative Example 3

An interior material of this comparative example was obtained by carrying out a production process similar to that in Example 1 with the exception that the sound absorbing material layer includes 15% by weight of the polyester fiber (A), 65% by weight of the polyester fiber (B) and 20% by weight of the polyester (C) .

### Comparative Example 4

An interior material of this comparative example was obtained by carrying out a production process similar to that in Example 1 with the exception that the sound absorbing material layer includes 97% by weight of the polyester fiber (A) and 3% by weight of the polyester (C) so that no polyester fiber (B) was included.

### Comparative Example 5

An interior material of this comparative example was obtained by carrying out a production process similar to that in Example 1 with the exception that the sound absorbing material layer had a thickness of 60% of the total thickness of the fiber bulk material and a density of 600 g/m², and that the moldable layer had a thickness of 40% of the total thickness of the fiber bulk material and a density of 400 g/m².

### Comparative Example 6

An interior material of this comparative example was obtained by carrying out a production process similar to that in Example 1 with the exception that the sound absorbing material layer had a thickness of 97% of the total thickness of the fiber bulk material and a density of 970 g/m², and that the moldable layer had a thickness of 3% of the total thickness of the fiber bulk material and a density of 300 g/m².

### Experiment

(1) Measurement of Sound Insulating Performance

The interior materials (samples) prepared according to Examples, Earlier Technology, Comparative Examples were subjected to a sound transmission loss test in order to evaluate a sound insulating performance.

The sound transmission loss test was conducted as follows: The test was to measure a sound transmission loss by using two reverberation rooms, according to JIS (Japanese Industrial Standard)—K1416. First, the samples (interior material) prepared according to Examples, Earlier Technology, and Comparative Examples were formed to be uniform in surface density. Then, an aluminum plate having a thickness of 1 mm and a synthetic resin (polymer) layer having a density of 4.0 kg/ m² were laminated on each sample (interior material) in such a manner the sample was located between the aluminum plate and the resin layer, thus preparing an laminated structure. This laminated structure was sealingly set between a sound source-side reverberation room (in which a sound source or speaker was located) and a measurement-side reverberation room, in which the aluminum plate was located at the side of the sound source-side reverberation room while the resin layer was located at the side of the measurement-side reverberation room. In this state, a sound pressure generated from the speaker in the sound source-side reverberation room was measured by a sound source-side microphone, while sound transmitted through the laminated structure was measured by a measurement-side microphone located in the measurement-side reverberation room thereby to obtain a sound pressure of sound passed through the sample (interior material). The sound transmission loss of the laminated structure (including the sample) was obtained by the difference between the sound pressure in sound source-side reverberation room and the sound pressure in the measurement-side reverberation room. The result of this test is shown in Table 1 in which the evaluation “A” represents the sound transmission loss (the mean value of a plurality of values measured at frequencies ranging from 100 to 6300 Hz) which was improved by not lower than +1 dB relative to that of the Earlier Technology 1; the evaluation “B” represents the sound transmission loss which was improved by a range from +1 dB to−1 dB relative to that of the Earlier Technology 1; and the evaluation “C” represents the sound transmission loss which was improved by not higher than −1dB (or degraded by not lower than 1 dB) relative to that of the Earlier Technology 1.

(2) Measurement of Moldability or Die-Following Ability

The interior materials (samples) prepared according to Examples, Earlier Technology, Comparative Examples were subjected to a pressing test in order to evaluate a moldability or die-following ability.

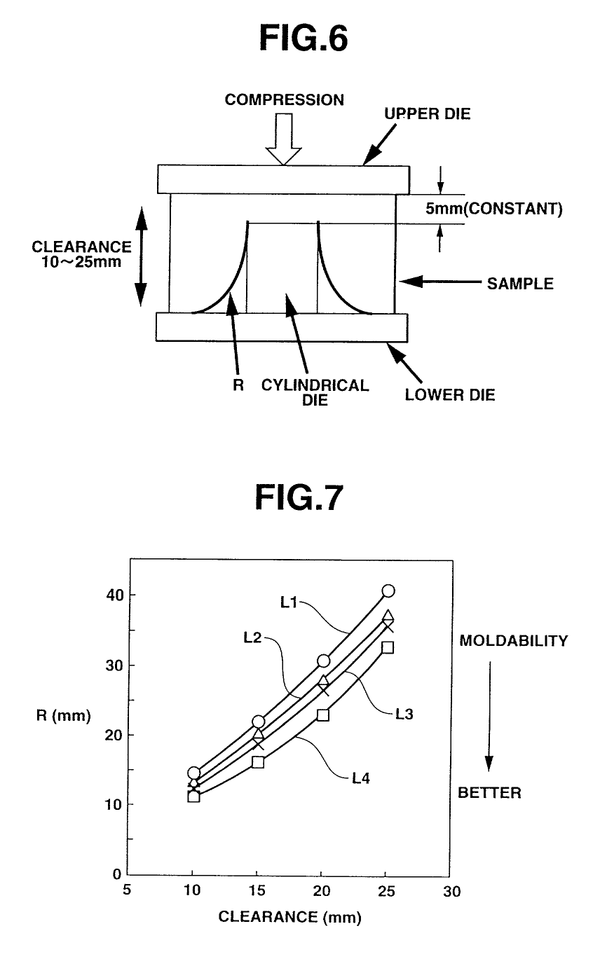

The pressing test was conducted as follows: Each of the interior materials (samples) was heated at 165° C. Then, a solid cylindrical die was mounted on the sample at the central part, upon which the die and sample were located upside down and set between upper and lower dies of a pressing machine as shown in FIG. 6. Compression was made on the sample with the cylindrical die in a manner that a clearance between the upper and lower dies was changed at 10, 15, 20 and 25 mm, so that four specimens were prepared for each sample. Here, the axial lengths of the cylindrical dies were 5 mm, 10 mm, 15 mm and 20 mm when the clearances was 10 mm, 15 mm, 20 mm and 25 mm, respectively, so that the distance (5 mm) between the upper die and the top of the cylindrical die was constant. As a result of this pressing test, the four specimens for each sample (interior material) had respective circular depressions formed at the lower surface of each specimen under the effect of the cylindrical dies, in which the circular depression has a generally cylindrical side wall having a curvature R in cross-section as shown in FIG. 6. At this time, the length (mm) of this curvature R was measured, upon which a linear regression was made with the length R to the clearance thereby to evaluate the moldability or die-following ability of the sample as shown in Table 1. In Table 1, the evaluation “A” represents an average curvature (R) length (in the four specimens) of not larger than −1 mm relative to that of Earlier Technology 1; the evaluation “B” represents the average curvature (R) length ranging from +1 to −1 mm relative to that of Earlier Technology 1; and the evaluation “C” represents the average curvature (R) length of not less than +1 mm relative to that of Earlier Technology 1. The linear regressions of some of the samples are graphically shown in FIG. 7 in which lines L1, L2, L3 and L4 represent respectively the sample of Comparative Example 1, the sample of Earlier Technology 1, the sample of Example 8 and the sample of Example 1.

TABLE 1

| | | Sound absorbing layer | | | | | | | Moldable layer | | | | | | |
|---|---|---|---|---|---|---|---|---|---|---|---|---|---|---|---|
| | | Fiber (A) | | Fiber (B) | | Fiber (C) | | | Fiber (D) | | Fiber (E) | | | Performance | |
| | Number | | Blended | | Blended | | Blended | Thick- | | Blended | | Blended | Thick- | | Sound |
| | of | Size | amount | Size | amount | Size | amount | ness | Size | amount | Size | amount | ness | Mold- | insulating |
| Sample | layers | (d) | (%) | (d) | (%) | (d) | (%) | (%) | (d) | (%) | (d) | (%) | (%) | ability | performance |
| Example 1 | 2 | 0.5 | 65 | 6 | 15 | 2 | 20 | 90 | 13 | 80 | 4 | 20 | 10 | A | A |
| Example 2 | ↑ | ↑ | ↑ | ↑ | ↑ | ↑ | ↑ | 70 | ↑ | ↑ | ↑ | ↑ | 30 | A | A |
| Example 3 | 3 | ↑ | ↑ | ↑ | ↑ | ↑ | ↑ | 80 | ↑ | ↑ | ↑ | ↑ | 10 | A | A |
| Example 4 | ↑ | ↑ | ↑ | ↑ | ↑ | ↑ | ↑ | 70 | ↑ | ↑ | ↑ | ↑ | 15 | A | A |
| Example 5 | 2 | ↑ | 80 | — | — | ↑ | ↑ | 90 | ↑ | ↑ | ↑ | ↑ | 10 | A | A |
| Example 6 | ↑ | ↑ | 95 | ↑ | ↑ | ↑ | 5 | ↑ | ↑ | ↑ | ↑ | ↑ | ↑ | B | A |
| Example 7 | ↑ | ↑ | 50 | ↑ | ↑ | ↑ | 50 | ↑ | ↑ | ↑ | ↑ | ↑ | ↑ | A | A |
| Example 8 | ↑ | ↑ | 65 | 6 | 15 | ↑ | 20 | ↑ | ↑ | 95 | ↑ | 5 | ↑ | B | A |
| Example 9 | ↑ | ↑ | ↑ | ↑ | ↑ | ↑ | ↑ | ↑ | 6 | 50 | ↑ | 50 | ↑ | A | A |
| Example 10 | ↑ | ↑ | ↑ | ↑ | ↑ | ↑ | ↑ | ↑ | — | — | 15 | 100 | ↑ | A | A |
| Example 11 | ↑ | ↑ | ↑ | ↑ | ↑ | ↑ | ↑ | ↑ | 100 | 80 | 4 | 20 | ↑ | A | A |
| Example 12 | ↑ | ↑ | ↑ | ↑ | ↑ | ↑ | ↑ | ↑ | 13 | ↑ | 100 | ↑ | ↑ | A | A |
| Example 13 | ↑ | ↑ | ↑ | ↑ | ↑ | ↑ | ↑ | ↑ | 2 | ↑ | 4 | ↑ | ↑ | B | A |
| Example 14 | ↑ | ↑ | ↑ | ↑ | ↑ | ↑ | ↑ | ↑ | 13 | ↑ | 2 | ↑ | ↑ | A | A |
| Earlier | 2 | 2 | 60 | 6 | 20 | 2 | 20 | 95 | 2 | 95 | 2 | 5 | 5 | B | B |
| tech. 1 | | | | | | | | | | | | | | | |
| Earlier | 3 | ↑ | ↑ | ↑ | ↑ | ↑ | ↑ | 88 | ↑ | ↑ | ↑ | ↑ | 6 | B | B |
| tech. 2 | | | | | | | | | | | | | | | |
| Comp. | 1 | 0.5 | 65 | 6 | 15 | 2 | 20 | 100 | — | — | — | — | — | C | A |
| Example 1 | | | | | | | | | | | | | | | |
| Comp. | 2 | ↑ | ↑ | ↑ | ↑ | ↑ | ↑ | 90 | 13 | 95 | 4 | 5 | 10 | C | A |
| Example 2 | | | | | | | | | | | | | | | |
| Comp. | ↑ | ↑ | 15 | 6 | 65 | ↑ | ↑ | ↑ | ↑ | 80 | ↑ | 20 | ↑ | B | C |
| Example 3 | | | | | | | | | | | | | | | |
| Comp. | ↑ | ↑ | 97 | — | — | ↑ | 3 | ↑ | ↑ | ↑ | ↑ | ↑ | ↑ | C | A |
| Example 4 | | | | | | | | | | | | | | | |
| Comp. | ↑ | ↑ | 65 | 6 | 15 | ↑ | 20 | 60 | ↑ | ↑ | ↑ | ↑ | 40 | A | C |
| Example 5 | | | | | | | | | | | | | | | |
| Comp. | ↑ | ↑ | ↑ | ↑ | ↑ | ↑ | ↑ | 97 | ↑ | ↑ | ↑ | ↑ | 3 | C | A |
| Example 6 | | | | | | | | | | | | | | | |

Table 1 depicts that the interior materials according to the present invention are largely improved in sound absorbing ability over those of Earlier Technology corresponding to conventional interior materials. Additionally, FIG. 7 depicts that the moldability is better in the interior materials according to the present invention. From comparison between Example 8 and Earlier Technology 1, it is apparent that the moldability in Example 8 is improved by enlarging the size of fibers of the moldable layer over that of the main fiber in Earlier Technology 1 although the moldability of the sound absorbing material layer in Example 8 is degraded by including fibers smaller in size as being understood from Comparative Example 1.

As appreciated from the above, the interior material according to the present invention can be largely improved in sound insulating performance of the automotive vehicle while contributing to weight-lightening of automotive parts, for example, by being used as the dash insulator of the automotive vehicle. Thus, according to the present invention, the sound absorbing material and the interior material can be largely improved in sound insulating performance while maintaining a high moldability thereof.

The entire contents of Japanese Patent Applications P11-01287 (filed Feb. 18, 1999) are incorporated herein by reference.

Although the invention has been described above by reference to certain embodiments of the invention, the invention is not limited to the embodiments described above. Modifications and variations of the embodiments described above will occur to those skilled in the art, in light of the above teachings. The scope of the invention is defined with reference to the following claims.

What is claimed is:

1. A sound absorbing material comprising:
first polyester fiber (A) in an amount ranging from 20 to 95 parts by weight, said first polyester fiber having a size smaller than 1 denier; and
second polyester fiber (C) in an amount ranging from 5 to 50 parts by weight, said second polyester fiber including a component having a softening point lower than that of said first polyester fiber by at least a temperature of 20° C., said second polyester fiber having a size ranging from 1 to 100 denier.

2. A sound absorbing material as claimed in claim 1, further comprising third polyester fiber (B) in an amount ranging from 1 to 5 parts by weight, said third polyester fiber having a size ranging from 1 to 100 denier.

3. An interior material comprising:
a sound absorbing material layer including
first polyester fiber (A) in an amount ranging from 20 to 95 parts by weight, said first polyester fiber having a size smaller than 1 denier, and
second polyester fiber (C) in an amount ranging from 5 to 50 parts by weight, said second polyester fiber including a component having a softening point lower than that of said first polyester fiber by at least a temperature of 20° C., said second polyester fiber having a size ranging from 1 to 100 denier; and
a first moldable layer laminated to said sound absorbing material layer and including
fourth polyester fiber (E) in an amount ranging from 5 to 100 parts by weight, said fourth polyester fiber having a size ranging from 1 to 100 denier.

4. An interior material as claimed in claim 3, wherein said moldable layer includes fifth polyester fiber (D) in an amount ranging from 1 to 95 parts by weight, said fifth polyester fiber including a component having a softening point higher than that of said fourth polyester fiber by at least a temperature of 20° C., said fifth polyester fiber having a size ranging from 1 to 100 denier.

5. An interior material as claimed in claim 4, wherein said fifth polyester fiber has a size ranging from 5 to 100 denier.

6. An interior material as claimed in claim 3, further comprising a second moldable layer laminated to said sound absorbing material layer and located at a surface opposite to the other surface at which said first moldable layer is located, said second moldable layer including said fourth polyester fiber (E) in an amount ranging from 5 to 100 parts by weight, said fourth polyester fiber having a size ranging from 1 to 100 denier.

7. An interior material as claimed in claim 3, wherein a total thickness of said sound absorbing material layer and a total thickness of said moldable layer are in a ratio of a value ranging from 40 to 95: a value ranging from 5 to 60.

8. A method of producing an interior material, comprising:
preparing a sound absorbing material layer including first polyester fiber (A) in an amount ranging from 20 to 95 parts by weight, said first polyester fiber having a size smaller than 1 denier, and second polyester fiber (C) in an amount ranging from 5 to 50 parts by weight, said second polyester fiber including a component having a softening point lower than that of said first polyester fiber by at least a temperature of 20° C., said second polyester fiber having a size ranging from 1 to 100 denier;
preparing a moldable layer including fourth polyester fiber (E) in an amount ranging from 5 to 100 parts by weight, said fourth polyester fiber having a size ranging from 1 to 100 denier; and
heat-treating said sound absorbing material and moldable layers at a temperature which is not lower than the highest one of the softening points of said second polyester fiber (C) and said fourth polyester fiber (E) and lower than the softening point of said first polyester fiber (A) by at least a temperature of 20° C., so that said sound absorbing material and moldable layers are bonded to each other.

9. A method of producing an interior material, comprising:
preparing a sound absorbing material layer including first polyester fiber (A) in an amount ranging from 20 to 95 parts by weight, said first polyester fiber having a size smaller than 1 denier, second polyester fiber (C) in an amount ranging from 5 to 50 parts by weight, said second polyester fiber including a component having a softening point lower than that of said first polyester fiber by at least a temperature of 20° C., said second polyester fiber having a size ranging from 1 to 100 denier, and third polyester fiber (B) in an amount ranging from 1 to 5 parts by weight, said third polyester fiber having a size ranging from 1 to 100 denier;
preparing a moldable layer including fourth polyester fiber (E) in an amount ranging from 5 to 100 parts by weight, said fourth polyester fiber having a size ranging from 1 to 100 denier, and fifth polyester fiber (D) in an amount ranging from 1 to 95 parts by weight, said fifth polyester fiber including a component having a softening point higher than that of said fourth polyester fiber by at least a temperature of 20° C., said fifth polyester fiber having a size ranging from 1 to 100 denier; and
heat-treating said superposed sound absorbing material and moldable layers at a temperature which is not lower than the highest one of the softening points of said second polyester fiber (C) and said fourth polyester fiber (E) and lower by at least a temperature of 20° C. than the lowest one of the softening points of said first polyester fiber (A), said third polyester fiber (B) and said fifth polyester fiber (D), so that said sound absorbing material and moldable layers are bonded to each other.

10. A method as claimed in claim 9, further comprising bonding said sound absorbing material and moldable layers to each other by using one of a needle punch method and an adhesive.

11. A method as claimed in claim 9, further comprising superposing said sound absorbing material and moldable layers one upon another before said heat-treating.

12. A method as claimed in claim 9, wherein said heat-treating is carried out in a condition where said sound absorbing material layer and said moldable layer are separate from each other, wherein said method further comprises superposing said sound absorbing material and moldable layers one upon another after said heat-treating; and bonding said sound absorbing material and moldable layers to each other by using one of a needle punch method and an adhesive, after said superposing.

13. A dash insulator for an automotive vehicle, comprising:
an interior material including
a sound absorbing material layer including first polyester fiber (A) in an amount ranging from 20 to 95 parts by weight, said first polyester fiber having a size smaller than 1 denier, and second polyester fiber (C) in an amount ranging from 5 to 50 parts by weight, said second polyester fiber including a component having a softening point lower than that of said first polyester fiber by at least a temperature of 20° C., said second polyester fiber having a size ranging from 1 to 100 denier; and
a first moldable layer laminated to said sound absorbing material layer and including fourth polyester fiber (E) in an amount ranging from 5 to 100 parts by weight, said fourth polyester fiber having a size ranging from 1 to 100 denier.

14. A dash insulator as claimed in claim 13, wherein said interior material further includes a second moldable layer laminated to said sound absorbing material layer and located at a surface opposite to the other surface at which said first moldable layer is located, said second moldable layer including said fourth polyester fiber (E) in an amount ranging from 5 to 100 parts by weight, said fourth polyester fiber having a size ranging from 1 to 100 denier, wherein said first and second moldable layers are positioned respectively to sides of engine compartment and passenger compartment of the vehicle.
